(19) United States
(12) Patent Application Publication
(10) Pub. No.: US 2026/0288998 A1
(43) Pub. Date: Sep. 24, 2026

(54) SYSTEMS AND METHODS FOR ANALYZING AND/OR OBFUSCATION OF DIGITAL AND/OR GEOSPATIAL PATTERNS

(71) Applicant: Knowmadics, Inc., Herndon, VA (US)

(72) Inventors: Michael Patrick Jenkins, Cohasset, MA (US); Calvin Leather, Boston, MA (US); Tyler Bastian, Wichita, KS (US); Dave Reinhard, Odessa, FL (US); Josh Fultz, Sanford, NC (US); Sean Kelly, Wakefield, MA (US)

(21) Appl. No.: 19/013,655

(22) Filed: Jan. 8, 2025

(51) Int. Cl. G06F 21/62; G06F 18/20

(52) U.S. Cl. CPC G06F 21/6227; G06F 18/20

(57) ABSTRACT

Certain examples of the present technology provide a computing system for detection and breaking or obfuscation of patterns. The computing system may include one or more processors configured to: receive, from one or more sources, use information related to use of a device; identify, based on the received use information, one or more detectable patterns; and based on detecting that the one or more detectable patterns satisfy one or more conditions, output information indicating that one or more patterns are detectable and/or one or more actionable recommendations for breaking or obfuscating the detectable patterns.

### STATEMENT CONCERNING FEDERALLY FUNDED RESEARCH

This invention was made with Government support under FA864924P0642 awarded by USAF Research LAB AFRL SBRK. The Government has certain rights in the invention.

### TECHNICAL FIELD

Certain examples of the present technology described herein relate to systems and/or methods for analyzing and/or obfuscation of information about use of computing systems and, more specifically, systems and/or methods for analyzing and/or obfuscation of information about digital and/or geospatial/spatiotemporal patterns.

### BACKGROUND AND SUMMARY

The development of computing systems and networking technologies has improved people's quality of life. Such computing systems include, for example, mobile devices and Internet of Things (IoT) devices, which are interconnected and communicate with other computing systems using wired and wireless networks. The computing systems can be included in or associated with physical devices or products to provide additional features and/or services.

Information related to the use of the computing systems can be utilized to identify interests, behaviors, or habits. As an example, the location of a computing system at certain times during the day can be used to determine movement habits, eating habits, recreational habits, or working habits. The identified interests, behaviors or habits can be used by advertising firms for profiling individuals to serve targeted ads. The information related to the use of the computing systems can also be used to obtain personal details about someone, without their knowledge or consent, and used for criminal activity.

Certain example embodiments help address the above-described and/or other concerns. For example, certain example embodiments help reduce or prevent the utilization of use information to obtain information about individuals'Pattern-of-life (POL), habits of using the computing system, or patterns related to physical devices or products associated with the computing systems.

The features, aspects, advantages, and example embodiments described herein may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a flowchart illustrating a method for notification and obfuscation of patterns according to certain examples of the present technology;

FIG. 2 illustrates a system diagram including devices that may perform one or more of the operations described with reference to FIG. 1, according to certain examples of the present technology;

FIG. 3 is a flowchart illustrating method for providing notifications and obfuscation of patterns, according to certain examples of the present technology;

FIG. 4 is a flowchart illustrating a method for providing warnings for detectable usage patterns, according to certain examples of the present technology;

FIG. 5A illustrates displaying a message indicating that a pattern has been detected and information about the pattern;

FIG. 5B illustrates displaying a message indicating that a pattern has been detected and instructions to modify a route or time;

FIG. 5C illustrates displaying a message indicating that a pattern has been detected and instructions to modify a specific portion of a route for a defined period of time;

FIG. 5D illustrates displaying a symbol indicating that a pattern has been detected;

FIG. 6A illustrates displaying a message indicating that a pattern related to RF emission has been detected and instructions to modify use of device;

FIG. 6B illustrates displaying a message indicating that a pattern has been detected and a recommendation to use alternate route;

FIG. 6C illustrates displaying a message indicating that a pattern has been detected and a heat map;

FIG. 6D illustrates displaying a message indicating that a pattern has been detected and a color-coded route; and

FIG. 7 is a block diagram of an exemplary computer system.

### DETAILED DESCRIPTION

Certain examples of the present technology relate to providing systems and/or methods for predicting ability to detect Pattern-of-life (POL) and providing notifications about being able to make such detection and/or recommendations for obfuscation of POL. The present technology helps to reduce the ability of adversaries to exploit digital and geospatial data by leveraging advanced AI/ML techniques to analyze, predict, and obfuscate the digital and geospatial POLs.

Certain examples of the present technology provide systems and methods that can enhance the survivability and effectiveness of operations by: generating and interpreting complex PoLs from diverse data sources (RF, geospatial, video, IoT); providing real-time indications and warnings when detectability thresholds are approached or exceeded; and recommending dynamic obfuscation strategies to mask or alter PoLs and reduce adversarial detection.

Certain examples of the present technology provide systems and methods that use AI/ML models for data analysis and pattern recognition, combined with an intuitive interface for real-time threat detection and strategy recommendations. The system may be designed for interoperability with existing communication and data systems. The system may include adaptive algorithms to cater to various operational environments and threat scenarios.

Certain examples of the present technology provide systems and methods use the AI/ML models for Pattern of Life (PoL) analysis utilizing advanced AI/ML techniques to analyze and interpret complex PoLs. The AI/ML models may featurize and process data from various sources to identify and map the behavioral patterns of users or groups of users.

Certain examples of the present technology provide systems and methods that include a threat detection and alert system that can function as a real-time surveillance mechanism. The system may continuously monitor the incoming data, or already established PoLs, to detect any patterns or activities that may signal a potential threat or risk of detection by adversaries.

Certain examples of the present technology a dynamic obfuscation and counter-detection strategies recommender that can provide one or more actionable recommendations. Based on the analysis and threat detection, the system may suggest behavioral strategies (e.g., leave a different time of day, take a different route, change schedule, change time, change sequence, change duration, change route of travel, change speed of travel, change means of travel, use a different phone, leave a device behind) to obfuscate or alter the detected PoLs, thereby reducing the likelihood of adversarial detection and enhancing operational security.

Certain examples of the present technology provide APIs and other interfaces that can be seamless integration with existing systems, such as command and control or Common Operational Picture (COP) interfaces like 360 Aware's®. Seamless integration can ensure that the systems of the present technology providing analytics and insight can be effectively visualized and utilized in real-time operational contexts.

Certain examples of the present technology provide one or more of the following features: usage of clustering and comparison algorithms on historic and/or live position data to identify repeat trips by the same user or a group of users; generation of multiple classes of recommendations to reduce the likelihood that behavior patterns result in a predictable pattern; inclusion of RF patterns of life in isolation as well as in combination with geospatial/spatiotemporal patterns; and/or combination of RF/communication signal data with position, movement, and time information to assess emerging patterns of life.

Examples of the present technology may provide at least the following technical advantages: analyzing and interpreting complex patterns of life (PoLs) using AI/ML algorithms goes beyond the capabilities of basic privacy tools, as it actively identifies patterns that could be exploited by adversaries, rather than just hiding digital footprints; unlike VPNs and similar services that primarily react to privacy breaches, the present technology proactively anticipates potential surveillance threat and provides insight to recommend strategic countermeasures; integration of diverse data sources, including RF, geospatial/spatiotemporal or, and visual intelligence, offers more comprehensive insights verses unidimensional competitors; providing customized recommendations to specifically obfuscate the PoLs of users based on what is being observed in near-real time; enabling a deeper understanding of potential threats and more effective counteractions; ability to analyze and obfuscate digital and geospatial PoLs enabling the users to move and operate with a significantly reduced risk of detection; helping planners anticipate and mitigate risks associated with electronic and digital signatures by providing various simulated scenarios based on collected data; detailed data analysis offers insights into the effectiveness of obfuscation strategies and inform future tactics and training; reduces the risk of user's operational patterns being detected and exploited by external threats, thereby enhancing the overall security posture; allows for monitoring digital and location-based behaviors of employees by establishing normal behavioral patterns and detecting anomalies to identify potential insider threats at an early stage, allowing for prompt intervention; and/or reduction of visibility through understanding and adapting to PoLs of other devices.

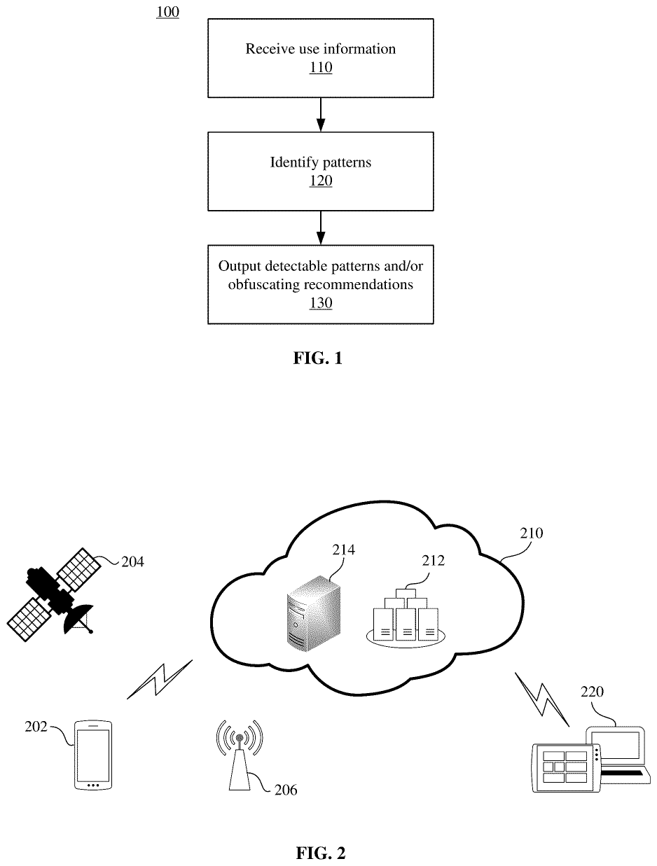

FIG. 1 is a flowchart illustrating a method 100 for notification and obfuscation of patterns according to certain examples of the present technology. The method 100 may include receiving use information related to use of a device 110, identifying one or more detectable patterns based on the received use information 120, and outputting information indicating that a pattern is detectable and/or obfuscating recommendation(s) 130. One or more of the steps shown in FIG. 1 may be omitted, repeated, and/or provided in a different order according to some examples of the present technology.

FIG. 2 illustrates a system diagram including devices that may perform one or more of the operations described with reference to FIG. 1, according to an example of the present technology. In FIG. 2, a device 202 may communicate with a processing system 210 including a database 212 and a server 214. The processing system 210 may be a cloud computing system comprising a memory and one or more processors comprising processing circuitry. The device 202 may be a mobile device, an Internet of Things (IoT) device, and/or a wearable device (e.g., smartphone, smart glasses, smart ring, fitness tracker). In some examples, the device 202 may be included in or associated with a physical device or a product (e.g., a vehicle, a container, a robot, or machinery).

The device 202 may communicate via a communication network including one or more nodes 206 (e.g., communication towers or wireless access points) and a satellite 204. Use information of the device 202 may be obtained by the device 202 and/or the server 214. The use information may include location information of the device 202 and/or signal levels of the device 202 across a radio frequency (RF) spectrum. In some examples, location information (e.g., GPS latitude and longitude) may be determined based on data received from the nodes 206 and/or the satellite 204. The device 202 and/or the server 214 may obtain data indicating the signal levels of the device 202 across a radio frequency (RF) spectrum based on communication operation performed by the device 202. The device 202 and the server 214 may exchange the use information with each other.

The server 214 may receive use information related to use of the device 202, identify one or more detectable patterns based on the received use information 120, and output information indicating that a pattern is detectable and/or obfuscating recommendation(s) 130. Historical use information may be received by the server 210 from the database 212 and/or the device 202. Based on the historical use information and live use data, the server 214 may determine if one or more pattern(s) are detectable from the use data, and/or what actions can be taken to reduce or eliminate the detection of patterns.

The information indicating that a pattern is detectable and/or obfuscating recommendation(s) may be transmitted to the device 202 or to another device 220. The information indicating that the pattern is detectable and/or the obfuscating recommendation(s) may be output to a user of the device 202 or another device 220. The output may be provided via a speaker and/or a display. The information indicating that the pattern is detectable and/or the obfuscating recommendation(s) may be displayed on a display of the mobile device 202, a display associated with the mobile device 202, or a display of the other device 220. The other device 220 may be associated with an entity or a user responsible for security and/or privacy of the device 202 and/or a user associated with the device 202.

In one example of the present technology, one or more operations performed by the server 214 may be performed by the device 202. For example, the device 202 may receive use information related to use of the device 202, identify one or more detectable patterns based on the received use information 120, and/or output information indicating that a pattern is detectable and/or obfuscating recommendation(s) 130.

The use information of a device may include information about how the device was used in the past and the present use of the device. The use information may include information about past and current location, orientation, velocity, and acceleration of the device. The location information may include GPS latitude and longitude information provided at predetermined intervals (e.g., 1 second precision). The velocity and/or acceleration of the device may be provided in three dimensions.

In some examples, the use information may include information about application(s) executed by the device, activation and deactivation of features of the device (e.g., a speaker or a camera), communication protocols or frequency used by the device (e.g., Bluetooth, WiFi or mobile data, 2G, 3G, 4G, LTE, 5G, 6G, and/or satellite communication), access point use, and/or connectivity to other devices (e.g., a battery bank, an external speaker, a vehicle, and/or a storage device). The use information may include signal levels of signals used for communication, such as signal levels across the radio frequency (RF) spectrum. The use information may include signal information including or more of signal strength, signal frequency/type (WiFi, BT, cellular 4G, 5G) packet data size and timing, cellphone tower connection/sector, access point connections.

Historical use information and current use information may be received from one or more sources. The one or more sources may include storage included in the device, storage external to the device (e.g., a server, cloud storage, another device provided near the device or at another location), one or more sensors included in the device and/or one or more sensors external to the device. The one or more sensors may include a proximity sensor, an accelerometer, a gyroscope, a compass, a barometer, a magnetometer, a thermometer, a biometric sensor, microphone, camera, or a GPS. As current use information is captured, all or portions of the current use information may be included in the historical use information. The use information may be queried from a database and/or received live via a streaming data connection. The one or more sources may include organizations providing use data (e.g., surveillance company, communication service provider, government agency, and/or hacked data repository).

The use information may be received from sources that do not include the device or are not associated with the device. The use information may include location data from any tracker, and/or RF data received from any survey collector. In some examples, the use information may include location information of the device determined by a communication network based on use of the communication network by the device. In this example, the use information may include information about which communication towers, access points and/or mobile devices the device made communication connections with, amount of data transmitted and/or received, and/or amount of time the device maintained the connection.

One type of use information may be associated with one or more other types of use information. For example, the acceleration information and/or velocity information may be associated with the location information and/or time information. In some examples, each of the use information may be associated with time information and location information.

One or more of the use information may be captured in real time continuously and one or more of the use information may be captured in real time at predetermined intervals. The use information captured continuously may include acceleration data and/or velocity data. The use information captured at intervals may include location information, image data, and temperature data.

In some examples, the use information that does not satisfy one or more conditions may be discarded and/or use information that satisfy the one or more conditions may be stored and/or used in the analysis. The one or more conditions may include that the use information is available for a time period that exceeds a time threshold, that the use information (e.g., velocity or acceleration) exceeds a motion threshold, that the use information exceeds a predetermined amount of data, and/or that the use information exceeds a predetermined value (e.g., a preset signal level or power level). Different thresholds may be set for different use data.

In one example, when the movement data (e.g., position information from a GPS sensor) does not exceed a preset movement threshold, it may be assumed that the device is stationary and the amount of movement data detected may be set to zero to reduce the amount of data that needs to be stored and/or processed in the analysis. In another example, the use information may include information about the orientation of the device and the predetermined condition may include that a predetermined change in the orientation of the device is detected and, based on detecting the predetermined change, the change in the orientation may be recorded and associated with a time and/or location data. In another example, a predetermined condition with one type of use information (e.g., acceleration exceeds a predetermined amount) may trigger the capture, storage, and/or analysis of another type of use information (e.g., location information captured by the GPS or sound captured by the device).

In some examples, the use information may be processed, and/or transformed. In one example, the motion formation (e.g., acceleration data) may be grouped into multiple ranges and each range may be represented by a symbol (e.g., 1 or 0). In another example, the use information (e.g., RF data or acceleration data) may be processed or transformed to the frequency domain (e.g., using fast Fourier transform (FFT)). The resonant frequencies and/or peak amplitudes may be extracted from the frequency domain. The use information including the RF data may be transformed into FFT-based power spectrum density.

The use information may be used to identify one or more patterns 120. The patterns may include usage patterns of the device. The patterns may include POLs. Identifying the patterns may include identifying when the historic and/or current use information can be used to identify patterns in behavior of a user associated with the device and/or use of the device. Detecting the pattern may include predicting when the use information can be used to extract patterns and reveal the presence and intentions of the user or group of users.

In one example, a pattern may be detected when a certain activity (e.g., traveling a specific path) has been performed a predetermined number of times. In another example, a pattern may be detected when a certain activity (e.g., traveled path) has been performed a predetermined number of times within the same time period (e.g., same time on multiple days). In one example, a pattern may be detected when a certain activity (e.g., traveling a specific path) has been performed by a certain number of users that share a common characteristic and/or belong to a same group. The patterns may be identified from one or more of the different types of use information.

In some examples, the detection of the patterns may include using user-related metadata, such as the labels and locations the user frequently visits, such as work and home. The detection of the patterns may include detecting patterns in the path travelled between the work and/or home locations or detecting deviations from the fastest or the shortest path between the work and/or home. The metadata may be stored on the device or in a database remote to the device. The metadata may include demographic information about the user of the device that is predicted based on the use information, entered by the user, and/or associated with an account of the user.

In some examples, the detection of the patterns may include using environmental data such as weather, traffic conditions, and events occurring in the area (e.g., conferences or sports activities). The environmental data may be used to determine how certain conditions change behavior, and predications can be made that under certain conditions (e.g., when it rains) a path traveled by a user is changed from one path to another path. Alternatively, the environmental conditions may be used to predict when certain behaviors are not taken. For example, when the environmental conditions indicate that the time to travel between work and home exceeds a certain limit, the POL habit may indicate that the user will delay the trip home. The system may receive historical and current environmental conditions, determine patterns between the environment conditions and the actions of the user, and make predictions based on the patterns.

Outputting the information indicating that a pattern is detectable and/or obfuscating recommendation(s) 130 may include sending the information to the device for output by the device and/or to another device for output by the other device. The information may be transmitted to multiple devices including the device for which the pattern is determined and to a device associated with another user (e.g., security personnel or privacy company). In some examples, the notification and the obfuscating recommendation(s) may be sent to each member of a group to which the user of the device belongs.

The information for output may include human-readable warnings for display to the user to indicate when a usage pattern is overly repetitive. Examples of the human-readable warnings include: indications of repeated trajectories, like “You have traveled between your home and café X repeatedly over the last week at the same time and using the same route,” and/or indications of repeated and anomalous RF emissions, like, “You have used an unusual frequency to transmit in this area for the time of day,” or, “You frequently transmit using this frequency from this position.” The information may be output via a speaker using text to voice models, or via graphics displayed in a user interface (e.g., a graphic displayed in a map application executable on the device).

The human-readable outputs may be combined with obfuscation recommendations, indicating possible behavior changes in order to prevent overly predictable behavior. The obfuscation recommendations may include: recommend to arrive or depart a location at an alternative time of day, recommend extending or condensing their travel time along a portion of a route, recommend altering travel path without changing destination, recommend to avoid a specific region for a period of time, recommend a time period and/or a region where a given device should or should not be powered down, recommend a time period and/or a region where a specific feature available on the device or an application on device should or should not be used, recommend a time period and/or a region where a given application should or should not be run on an RF-emitting device, recommend specific times and/or locations wherein a given protocol should or should not be used, and/or recommend time and/or locations where a given wireless access point should or should not be used. In some examples, the recommendation may include for when and/or where to power down or not power down the device, spectrum band usage, bandwidth consumption, application usage, and/or device behavior, such as when and/or where to enable BT/Wifi/cellular.

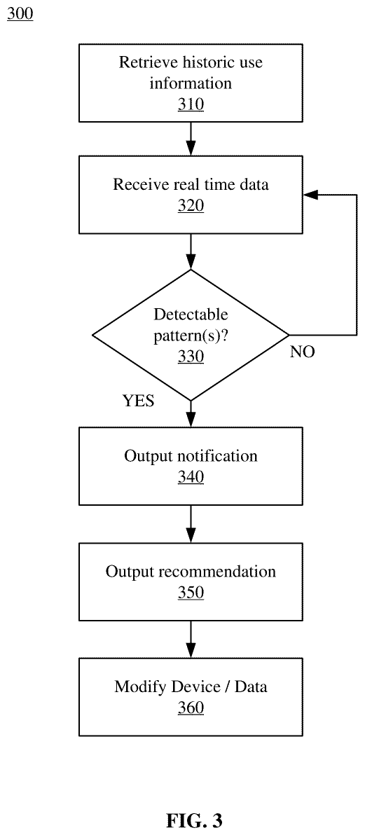

FIG. 3 is a flowchart illustrating method 300 for providing notifications and obfuscation of patterns according to certain examples of the present technology.

In operation 310, historical use information of a device is retrieved. The historical use information may be received from storage included in the device and/or from a database. The historical use information may include historical location, velocity, and acceleration data that is associated with time information, but is not so limited. The historical use information may also include signal levels used by devices across the RF spectrum during wireless communication. The signal levels may be associated with location and/or time information.

The historic use information may include information for a set period of time or information that consumes a set amount of memory or less. If the historic use information exceeds the set time period or memory amount, a portion of the historic use information exceeding the set time period or memory amount may be deleted. A different period of time and/or different amount of memory that can be used may be set for different types of use information. The period of time for location, velocity, and/or acceleration use information may be set to thirty days, sixty days, or ninety days, but is not so limited.

In operation 320, real time data for identifying use information may be received from one or more sources. The real time data may correspond to the same type(s) of data included in the retrieved historic use information.

The historical use information may include use information that is associated with a user of the device for which the real time data is received but was captured while the user was using one or more other devices associated with the user. In this example, the historical use information may include use information associated with the user while they were using a work smartphone, and the real time data may be provided by a personal smartphone of the user. In some examples, the historical use information may include use information associated with other users of a group to which the user belongs.

In operation 330, a determination is made whether the addition of the use information determined from the real time data in addition with the historic use information provide usage pattern that satisfy one or more conditions. The one or more conditions may include that the one or more patterns (e.g., POLs) are now predictable or overly repetitive. If the usage patterns do not satisfy the one or more conditions (NO in operation 330), the system may continue to receive real time data. The real time data may be received continuously or periodically. If the usage pattern(s) satisfy the one or more conditions (YES in operation 330), the system may perform one or more of operations 340, 350, and 360.

In operation 340, a notification is displayed indicating that usage pattern from the use information is repetitive and/or detectible. The notification may include a warning (e.g., a warning symbol) or information about what usage pattern is detected. The notification may be provided via text, image, symbol, and/or sound.

In operation 350, a recommendation for obfuscation of usage pattern is output. The recommendation may include instructions for modifying the user's behavior to ensure they cannot be targeted because their usage patterns are repetitive. The recommendation may identify a trip that is repetitive and predictable, and provide one or more actions that can be taken to make the trip less repetitive and predictable. The recommendation may include modifying the time of departure, the time of arrival, the destination, the stops that are made, the speed, the acceleration, the route, change schedule, change time, change sequence, change duration, change speed of travel, change means of travel, use a different phone, leave a device behind. The recommendation may include modifying how the device is used (e.g., turning on or off the device at certain locations and/or time(s), turning on and/or off certain applications and/or settings on the device at certain locations and/or time(s)).

The recommendations may be output one at a time, multiple at a time, or all at the same time. The recommendations may be output based on priorities associated with the recommendations. The priorities may be based on previous actions taken from a plurality of available actions by the user or other user(s). The priorities may be based on which recommendations will make it more difficult to detect a behavior pattern. The priorities may be based on which recommendations will be less complicated for the user to perform. For example, a recommendation that will not increase the amount of time it takes to travel from a first location to a second location may be provided a higher priority than a recommendation that will increase the time to travel from the first location to the second location.

In operation 360, one or more settings of the device may be modified to obfuscate usage pattern(s). The one or more settings of the device may be modified with or without the user(s) involvement. Modifying the one or more settings of the device may include stopping execution of an application, disabling a communication protocol on the device (e.g., Bluetooth or Wi-Fi), turning off the sound on the device, uninstalling an application, and/or deleting access point credentials from the device.

The performance of operations 340, 350, and 360 may be dependent on determining that one or more conditions are satisfied. Operation 340 may be performed when a first condition is satisfied (e.g., condition in operation 330 or likelihood that the pattern is detectable exceeding a first threshold), operation 350 may be performed when a second condition is satisfied (e.g., likelihood that the pattern is detectable exceeding a second threshold that is higher than the first threshold), and operation 360 may be performed when a third condition is satisfied (e.g., likelihood that the pattern is detectable exceeding a third threshold that is higher than the second threshold). In some examples, the third condition may include that there is an indication that the security of the device has been compromised and/or a user's account associated with the device has been compromised.

The second condition may include that the user has not taken any action to modify the usage pattern after the notification is output in operation 340. The third condition may include that the user has not taken any action based on the recommendation(s) provided in operation 350 within a preset amount of time. The third condition may include that additional real time data is received, increasing the predictability of the previously detected usage pattern(s).

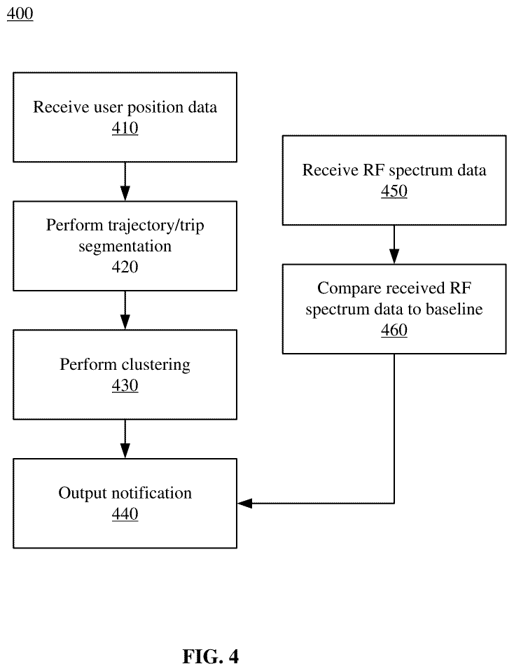

FIG. 4 is a flowchart illustrating a method 400 for providing warnings for detectable usage patterns according to certain examples of the present technology. While the operations of method 400 are described with reference to use information including position data and RF spectrum data, other use information may also be added and/or replaced, including position data and RF spectrum data.

In operations 410 and 450 data relating to use information is received. In operation 410, user position data is received. In operation 450, RF spectrum data is received. As discussed above, the data relating to the use information can be received from one or more sources and may include historical use information and use information captured in real time.

In operations 420 and 430 the user position data is processed to determine patterns. Trajectory and/or trip segmentation is performed in operation 420. In this operation, velocity and acceleration information may be used to segment out distinct trips. Periods of low velocity and/or acceleration may be used to identify one or more stopping points between trips. Velocity below a velocity threshold and acceleration below an acceleration threshold may identify the stopping points.

Clustering is performed in operation 430 to identify repeated trajectories based on the segmented trips. The clustering may include using clustering algorithms. In one example, the clustering may include using density-based spatial clustering of applications with noise (DBSCAN) and/or dynamic time warping (DTW) to identify repeated trajectories. DTW may be used to allow similar trips with slightly different velocity profiles to be aligned. DBSCANE clustering may be used in conjunction with dynamic time warping, and may be a performant clustering method that groups together similar trips across many trajectories.

The clustering may be performed for a single user, or across a group of users that are part of a common organization/organizational unit. When a group of users is considered, use information devices associated with each user of the group is received and processed to identify similar trips and their characteristics (e.g., starting location, stops made, ending location, traveled path, speed at certain location of path, duration of one or more stops).

In operation 460 the received RF spectrum data may be compared to a baseline of RF emissions. The comparison may be made using a baseline that is based on the time when the RF emissions are generated. The comparison may be made using a baseline of RF emissions in the area of identified trips, to identify unusual signals or signals that would otherwise stand out from the RF background. In some examples, the comparison to the baseline in operation 460 may be performed before the clustering, based on the segmented trips or the received position data. The baseline may be established by measuring RF signals in the locations of the paths and/or during execution of one or more applications by the device. The use of specific application(s) may create a district RF signature (e.g. based on PCAP transmission timing and size) within the noise of the region.

The baseline may be established by measuring RF signals in the locations of the paths and for a plurality of users for a period of time to establish baselines for different locations and different times of the day or week. The plurality of users may include users belonging to the general public or users belonging to a common organization/organizational unit.

DBSCAN and/or dynamic time warping may be used with machine learning (e.g., using supervised, unsupervised, and/or reinforced learning) to provide improved predictions.

In operation 440 a notification may be output providing a warning and/or recommendations for modifying behavior. A user receives output from the system and uses information provided in the output to modify their behavior to ensure they cannot be targeted. For example, the system may indicate to a user that a certain trip that they make each week is predictable, and that they might change their behavior by changing the time or route of the trip. Other obfuscation recommendations can be derived and recommended based on: timing (e.g., recommending the user(s) arrive and/or depart a location at an alternative time of day); velocity (e.g., recommending the user(s) extend and/or condense their travel time along a portion of a route); pathing (e.g., recommending the user(s) alter their travel path to a different route without changing destinations); alternate destination (e.g., recommending a similar destination viewed as analogous to a planned destination-for example, visit a different coffee shop of the same company a few blocks away or visit a different coffee shop of a different company); geofencing (e.g., provide a radial geofence that provides a region that should be avoided for a period of time); RF-emitting device usage (e.g., recommending a time period and/or region where a given device should or should not be powered down); RF-emitting device behavior0 (e.g., recommending a time period and/or region when a given application should or should not be run on an RF-emitting device); RF protocol usage (e.g., recommending specific times and/or locations when a given protocol (e.g., Wi-Fi vs Cellular) should or should not be used); and/or access point usage (e.g., recommending and/or or locations where a given wireless access point should/should not be used).

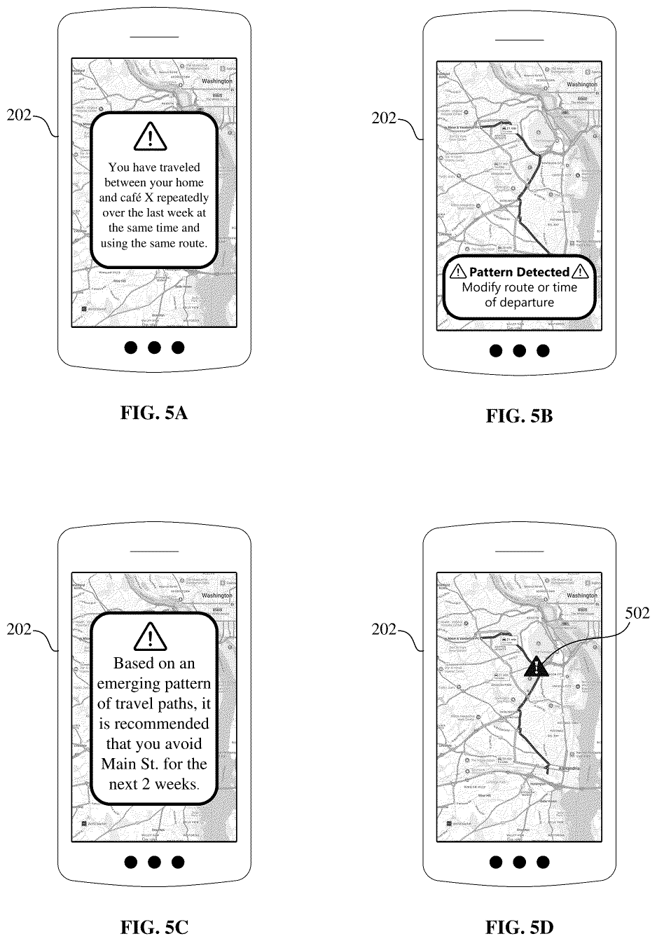

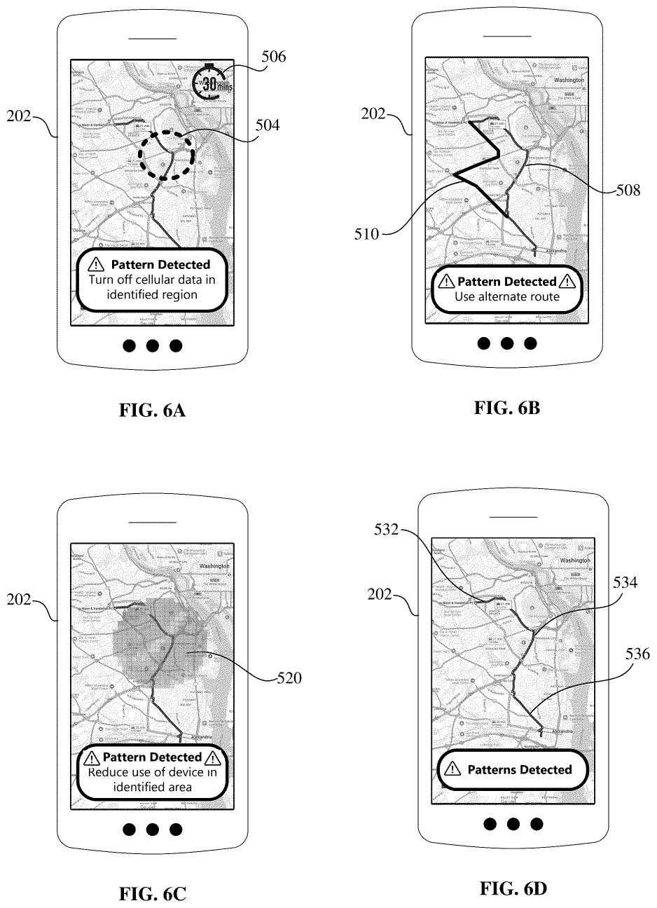

FIGS. 5A-5D and 6A-6D illustrate examples of user interfaces providing information about merging patterns and obfuscation recommendations. The user interfaces may be provided to the user of the device and/or to other personnel in charge of security and/or privacy. The user interfaces may be provided to users on their devices while they are physically moving around the real world. The user interfaces may be designed to be included primarily on mobile devices, but flexibly via any combination of a mobile application, a web-app, or a contained plug-in for third-party applications (e.g., team awareness application, Android Team Awareness Kit (ATAK) or iOS Team Awareness Kit (ITAK)).

The user interfaces may come in two classes-Natural Language (NL) and geospatial. In the NL implementation, written recommendations may be generated using a Generative Pre-trained Transformers (GPT) models. The GPT models may provide application(s) the ability to create human-like text or voice and content (images or videos) for relaying information about merging patterns and obfuscation recommendations to the user. The delivery of information to the user using the GPT model may provide concise and easy to deliver information in the app or even via a simple message (e.g., SMS).

A geospatial interface may be created using KML layers (also known as Keyhole Markup Language layers) that allow the UIs to be readily displayed on most third-party geospatial visualization services. The geospatial UI may use graphical iconology and geometries. Icons and/or geometries may be placed on the map to denote locations and/or areas of interest. The encoded symbol for the icon may indicate the reason it is being flagged with a metadata label. For example, an octagon icon on a building is used to indicate a location the user should avoid. Appended to that icon may be a countdown timer that indicates how long they must avoid that location.

In some examples, based on predicting that the one or more patterns satisfy one or more conditions, operation 130 may include or operation 130 may be replaced with generating use information related to one or more sources of use information for prevention or obfuscation detection of the one or more patterns. In this example, the system or method may insert additional data and associate the data with the device so that it is harder to detect the one or more patterns. The additional data may include use information, such as location information of the device and/or signal levels of the device across a radio frequency (RF) spectrum, but is not so limited. The additional use information may include information that does not correspond to actions performed by the device and that will prevent or obfuscate detection of the one or more patterns

FIG. 5A illustrates displaying a message indicating that a pattern has been detected and information about the pattern. As shown in FIG. 5A, the message may be displayed overlapping an application (e.g., a map application). The message may be displayed when the determination is made that a pattern is predictable and/or the system indicates that the user is about to take another trip that corresponds to the previously detected pattern. The notification may be displayed within an executing application related to navigation or related to a team awareness service, or by the system of the device 202.

FIG. 5B illustrates displaying a message indicating that a pattern has been detected and instructions to modify a route or time. As shown in FIG. 5B, the message may be displayed overlapping an application (e.g., a map application). The message may be displayed when the determination is made that a pattern is predictable and/or the system indicates that the user is about to take another trip that corresponds to the previously detected pattern. The notification may be displayed within the application related to navigation or related to a team awareness service, or by the system of the device 202.

FIG. 5C illustrates displaying a message indicating that a pattern has been detected and instructions to modify a specific portion of a route for a defined period of time. The message may be displayed when the determination is made that a pattern is predictable and/or the system indicates that the user is about to take another trip that corresponds to the previously detected pattern. The notification may be displayed within the application related to navigation or related to a team awareness service, or by the system of the device 202.

FIG. 5D illustrates displaying a symbol 502 indicating that a pattern has been detected. The symbol 502 may be displayed overlapping a route the user intends to travel. The symbol may be selectable to provide additional data about the pattern. As an example, based on the user selecting the symbol 502, information shown in the user interfaces of other figures may be displayed in the user interface shown in FIG. 5D. The symbol 502 may be displayed at a location on the map where the pattern is detected and/or where to modify the behavior included in the obfuscation recommendation.

FIG. 6A illustrates displaying a message indicating that a pattern related to RF emission has been detected and instructions to modify use of device. As shown in FIG. 6A, the map includes an indicator 504 providing a region where the cellular data of the device should be turned off or not used. The message and the symbol 504 may be displayed when the determination is made that a pattern is predictable and/or the system indicates that the user is about to take another trip that corresponds to the previously detected pattern. A timer 506 may be displayed to indicate how long the device should be turned off or not used. Based on this information the user may not only modify the route and/or use of the device but also modify when the trip is started.

FIG. 6B illustrates displaying a message indicating that a pattern has been detected and a recommendation to use alternate route 510. As shown in FIG. 6B, the message may be displayed overlapping an application (e.g., a map application). The map may include an original route 508 and may also be modified to include an alternate route 510. The alternate route 510 may be determined based on the determined pattern(s) and include a route and/or stops that do not conform to the determined pattern(s).

FIG. 6C illustrates displaying a message indicating that a pattern has been detected and a heat map 520. As shown in FIG. 6C, the message may be displayed overlapping an application (e.g., a map application). The message and/or heat map 520 may be displayed when the determination is made that a pattern is predictable and/or the system indicates that the user is about to take another trip that corresponds to the previously detected pattern. The heat map 520 may be displayed in an overlapping manner with the map indicating an area on the map where predicated patterns are identified. The heat map 520 may indicate areas where there is greater predictability of patterns (e.g., along a route where the user has traveled and/or used his device for communication in the past). The user may use the information of the heat map to modify the route, destination, travel speed, and/or use of the device. The user interface may display or hide the heat map 520 in response to the user making an input operation on the displayed message.

In some examples, instead of the heat map, the route selected by the user may be color coded to indicate portions of the route that have greater predictability of patterns. FIG. 6D illustrates displaying a message indicating that a pattern has been detected and a color-coded route (colors are not illustrated in grayscale image of FIG. 6D). The color-coded route may include a first portion of the route 532 that is colored yellow, a second portion of the route 534 that is colored red, and a third portion of the route 536 that is colored green. A red colored portion of the route 534 may indicate the portion of route where there is high predictability of the user using their device for communication, a yellow colored portion of the route 532 may indicate the portion of the route that includes an average predictability of the user using their device for communication, and a green colored portion of the route 536 may indicate the portion of the route where there is low predictability of the user using their device. The user may modify the use of their device based on the colors provided on the route. In some examples, instead of areas showing predictability of using the device for communication, the color-coded route may include information for predictability of other uses of the device or predictability of different uses of the device.

In some examples, the communication capabilities of the device may be automatically restricted in portions of the route that exceed a set limit of pattern predictability. In some examples, the map application may automatically plan a route based on the predicted patterns without interaction by the user. In this example, the map application may not provide a user an option to take a route that is predictable based on previous usage patterns.

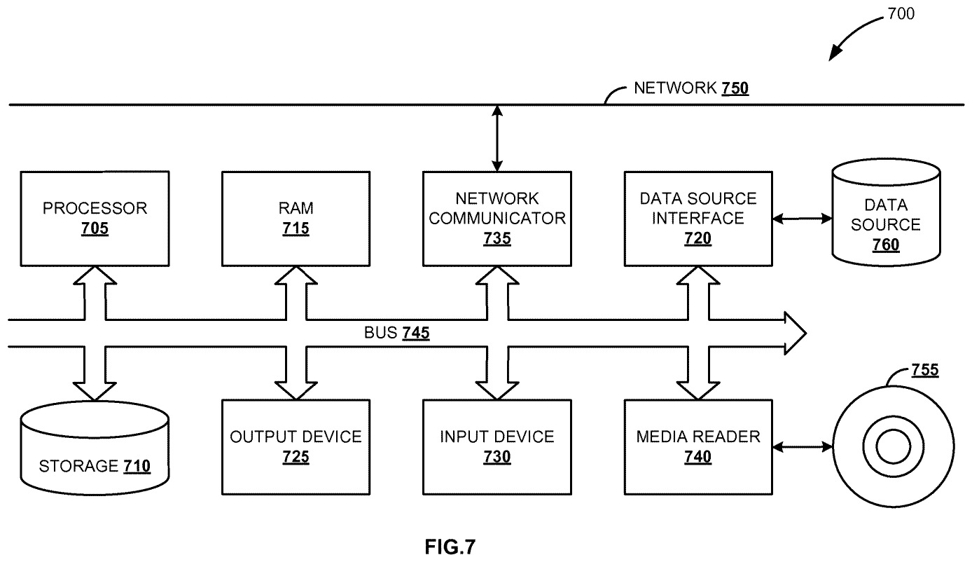

FIG. 7 is a block diagram of an exemplary computer system 700. The computing system 700 may include a mobile and/or handheld device, a cloud system, a server, or a terminal that is coupled to a remote processing system. The computer system 700 may correspond to the device 202, the server 214 and/or the device 220 shown in FIG. 2. One or more components illustrated in the exemplary computer system 700 may be provided external to the computer system 700.

The computer system 700 may include at least one processor 705 comprising processing circuitry that executes software instructions or code stored on a computer readable storage medium 755 to perform the methods illustrated in this application. The processor 705 can include a plurality of cores and/or a plurality of processors comprising processing circuitry configured to, individually and/or collectively, to perform the operations of the disclosed methods. The one or more processors may include a central processing unit (CPU), a graphics processing unit (GPU), microcontroller, and/or microprocessor. The one or more processors may include a processor configured to perform machine learning based on data stored in the computer system 700 and/or data received from other sources. The one or more processors 705 may be configured to receive use information related to use of a device, identifying one or more detectable patterns based on the received use information, and outputting information indicating that a pattern is detectable and/or obfuscating recommendation(s).

The computer system 700 may include a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The at least one processor 705 reads instructions from the RAM 715 and performs actions as instructed.

According to one embodiment, the computer system 700 further includes an output device 725 (e.g., a display or a speaker) to provide at least some of the results of the execution as output including, but not limited to, visual and/or audio information to user(s) and an input device 730 to provide a user or another device with means for entering data and/or otherwise interact with the computer system 700. In some examples, the output device 725 and the input device 730 may be provided as a touch screen display. The output device 725 may use to provide information about items selected for the identified space. The input device 730 may be used to receive user inputs selecting notification(s), routes, or modifying planned routes.

In some examples, the input device 730 and/or the output device 725 may be provided external to the computing system 700 and the computing system 700 may receive and/or send information to the input device 730 and/or the output device 725. Each of these output devices 725 and input devices 730 could be joined by one or more additional peripherals to further expand the capabilities of the computer system 700. The input device 730 may include one or more cameras and/or other sensors configured to capture data that can be used to determine use information. A network communicator 735 may be provided to connect the computer system 700 to a network 750 and in turn to other devices connected to the network 750 including other clients, servers, data stores, and interfaces, for instance. The modules of the computer system 700 are interconnected via a bus 745.

The computer system 700 may include a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer. A data source is an information resource. The data source 760 may store historical use information, ML models and/or determined patterns. Data sources include sources of data that enable data storage and retrieval. Data sources may include databases, such as, relational, transactional, hierarchical, multi-dimensional, object oriented databases, and the like.

The computer system 700 may be implemented in an augmented reality, AR, or virtual reality, VR, device. AR is an interactive experience of a real-world environment where the objects that reside in the real world may be enhanced by computer-generated perceptual information.

One or more operations described in this application may be performed by a processing system 700 including one or more processors (e.g., processors 705) coupled to memory. In some examples, the one or more processors may be a distributed system and/or include a cloud computing system. The Processing system may include hardware and/or software confirmed to perform machine learning and/or use artificial intelligence to perform one or more operations. One or more operations described in this application may be performed based on one or more trained ML/AI models. The models may be trained based on stored data, previous detected patterns and/or data received in real time. In some examples, one or more operations described in this application may be performed by or in association with an aggregation platform (e.g., 360° Aware® platform) and/or one or more devices and/or system(s) described in U.S. patent application Ser. No. 17/843,515, which is hereby incorporated by reference.

The processing system may provide alerts, notifications and recommendations, real time mapping, in app chat, live streaming, machine to machine processes for one or more operations described in this application. The alerts, notifications and recommendations may provide for individuals to stay informed in real time across all channels (e.g., email, SMS, mobile push notifications, and in-app activity feed) about detected patterns and/or actions that can be taken to reduce vulnerability. Real time mapping may provide tracking and protection of high value assets with real time location tracking on smartphones, smart watches, GPS tracker and radios (e.g., during the operational execution). In app chat may allow for individuals to stay connected and collaborate with all key stakeholder though one-to-one, group or live event in-app chat during any of the phases described in this application.

It will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

In the above description, numerous specific details are set forth to provide a thorough understanding of embodiments. The person skilled in the art realizes that the examples of the present technology by no means are limited to the preferred embodiments described above. On the contrary, many modifications and variations are possible within the scope of the appended claims. Additionally, variations to the disclosed embodiments can be understood and effected by the skilled person in practicing the claimed invention, from a study of the drawings, the disclosure, and the appended claims.

What is claimed is:

1. A computing system for prevention or obfuscation of patterns, the system comprising:
a memory; and
one or more processors comprising processing circuitry and coupled to the memory, the one or more processors, individually and/or collectively, configured to:
receive, from one or more sources, use information related to use of a device;
identify, based on the received use information, one or more detectable patterns; and
based on detecting that the one or more detectable patterns satisfy one or more conditions, output information indicating that patterns are detectable and/or one or more actionable recommendations for breaking or obfuscating the detectable patterns.

2. The system of claim 1, wherein the device includes a mobile device, the one or more sources include one or more sensors included in the device, the detectable patterns include behavior patterns, and the one or more actionable recommendations for breaking or obfuscating the detectable patterns are output and include instructions for modifying a traveled path, a stopped location, and/or time for traveling on the traveled path and/or the stopped location included in the one or more detectable patterns.

3. The system of claim 1, wherein the device includes a mobile device, the one or more sources include one or more sensors included in the device, the detectable patterns include spatiotemporal or geospatial patterns, the information indicating that patterns are detectable is output and indicates that a trip in the detectable patterns is predictable, and the one or more actionable recommendations for breaking or obfuscating the detectable patterns are output and instruct changing a time and/or a route of the trip.

4. The system of claim 1, wherein the one or more processors, individually and/or collectively, are configured to: identify signal levels emitted by the device across a radio frequency (RF) spectrum, wherein the one or more actionable recommendations for breaking or obfuscating the detectable patterns include recommendations for modifying a time period when an application emitting signals in the RF spectrum is used or a region where the application is used.

5. The system of claim 1, further comprising wherein the one or more processors, individually and/or collectively, are configured to: identify signal information about a signal emitted by the device, wherein the signal information includes signal levels emitted across a radio frequency (RF) spectrum, a signal strength, a signal frequency, a signal type, packet data size, packet data timing, cellphone tower connection or sector, and/or access point connection and wherein the one or more actionable recommendations for obfuscating the detectable patterns include recommendations for modifying a time period when an application emitting signals in the RF spectrum is used or a region where the application is used.

6. The system of claim 1, wherein the one or more processors, individually and/or collectively, are configured to: identify signal levels emitted by the device across a radio frequency (RF) spectrum, wherein the one or more actionable recommendations for breaking or obfuscating the detectable patterns include recommendations for when and/or where to power down or not power down the device, spectrum band usage, bandwidth consumption, application usage, and/or device behavior.

7. The system of claim 1, wherein the one or more processors, individually and/or collectively, are configured to: identify signal levels emitted by the device across a radio frequency (RF) spectrum, wherein the one or more actionable recommendations for breaking or obfuscating the detectable patterns include recommendations for when and/or where a given communication protocol or frequency should or should not be used by the device.

8. The system of claim 1, wherein the one or more detectable patterns are determined based on timing information, movement velocity and travel path of the device.

9. The system of claim 1, wherein the device includes a mobile device, the one or more sources include one or more sensors included in the mobile device, the detectable patterns include behavior patterns, and the one or more actionable recommendations for breaking or obfuscating the detectable patterns are displayed in a geospatial visualization service provided on the mobile device, the one or more actionable recommendations including a location that should be avoided and/or time information for avoiding the location.

10. The system of claim 1, wherein the device includes a mobile device, the one or more sources include one or more sensors included in the mobile device and configured to capture position information, velocity information and acceleration information, and wherein the one or more processors, individually and/or collectively, are configured to:
segment distinct trips based on the position information, the velocity information, and the acceleration information; and
cluster segmented trips including velocity profiles that do not exceed defined velocity variations and including trajectories that do not exceed defined trajectory variations,
wherein the one or more detectable patterns are identified based on the cluster trips.

11. The system of claim 10, wherein the use information includes signal levels emitted by the mobile device across a radio frequency (RF) spectrum, and wherein the one or more processors, individually and/or collectively, are configured to:
compare the signal levels emitted by the mobile device to a baseline of RF emissions in locations the mobile device has traveled and/or during execution of application by the device, wherein the information indicating that patterns are detectable and/or one or more actionable recommendations for breaking or obfuscating the detectable patterns are output based on the signal levels emitted by the mobile device exceeding the baseline of RF emissions in the locations the mobile device has traveled and/or during execution of application by the device.

12. The system of claim 11, wherein the one or more actionable recommendations for breaking or obfuscating the detectable patterns include:
recommendation for modifying a time period when an application emitting signals in the RF spectrum is use or a region where the application is used;
recommendation for when and/or where to power down or not power down the mobile device;
recommendation for when and/or where a communication protocol emitting signals in the RF spectrum should or should not be used by the mobile device; and/or
recommendation for when, where and/or which wireless access point should or should not be used by the mobile device.

13. The system of claim 1, wherein the device includes a mobile device, the one or more sources include one or more sensors included in the mobile device, and the one or more sources include one or more sensors included external to the mobile device.

14. A method for prevention or obfuscation of patterns, the method comprising:
receiving, from one or more sources, use information related to use of a device;
identifying, based on the received use information, one or more detectable patterns; and
based on detecting that the one or more detectable patterns satisfy one or more conditions, outputting information indicating that patterns are detectable and/or one or more actionable recommendations for breaking or obfuscating the detectable patterns.

15. The method of claim 14, wherein the device includes a mobile device, the one or more sources include one or more sensors included in the device, the detectable patterns include behavior patterns, and the one or more actionable recommendations for breaking or obfuscating the detectable patterns are output and include instructions for modifying a traveled path, a stopped location, and/or time for traveling on the traveled path and/or the stopped location included in the one or more detectable patterns.

16. The method of claim 14, wherein the device includes a mobile device, the one or more sources include one or more sensors included in the device, the detectable patterns include spatiotemporal or geospatial patterns, the information indicating that patterns are detectable is output and indicates that a trip in the detectable patterns is predictable, and the one or more actionable recommendations for obfuscating the detectable patterns are output and instruct changing a time and/or a route of the trip.

17. The method of claim 14, further comprising: identifying signal levels emitted by the device across a radio frequency (RF) spectrum, wherein the one or more actionable recommendations for obfuscating the detectable patterns include recommendations for modifying a time period when an application emitting signals in the RF spectrum is used or a region where the application is used.

18. The method of claim 14, comprising: identifying signal information about a signal emitted by the device, wherein the signal information includes signal levels emitted across a radio frequency (RF) spectrum, a signal strength, a signal frequency, a signal type, packet data size, packet data timing, cellphone tower connection or sector, and/or access point connection and wherein the one or more actionable recommendations for obfuscating the detectable patterns include recommendations for modifying a time period when an application emitting signals in the RF spectrum is used or a region where the application is used.

19. The method of claim 14, further comprising: identifying signal levels emitted by the device across a radio frequency (RF) spectrum, wherein the one or more actionable recommendations for breaking or obfuscating the detectable patterns include recommendations for when and/or where to power down or not power down the device, spectrum band usage, bandwidth consumption, application usage, and/or device behavior.

20. The method of claim 14, further comprising: identifying signal levels emitted by the device across a radio frequency (RF) spectrum, wherein the one or more actionable recommendations for breaking or obfuscating the detectable patterns include recommendations for when and/or where a given communication protocol or frequency should or should not be used by the device.

21. The method of claim 14, wherein the one or more detectable patterns are determined based on timing information, movement velocity and travel path of the device.

22. The method of claim 14, wherein the device includes a mobile device, the one or more sources include one or more sensors included in the mobile device, the detectable patterns include behavior patterns, and the one or more actionable recommendations for breaking or obfuscating the detectable patterns are displayed in a geospatial visualization service provided on the mobile device, the one or more actionable recommendations including a location that should be avoided and/or time information for avoiding the location.

23. The method of claim 14, wherein the device includes a mobile device, the one or more sources include one or more sensors included in the mobile device and configured to capture position information, velocity information and acceleration information, and the method further comprises:
segmenting distinct trips based on the position information, the velocity information, and the acceleration information; and
clustering segmented trips including velocity profiles that do not exceed defined velocity variations and including trajectories that do not exceed defined trajectory variations,
wherein the one or more detectable patterns are identified based on the cluster trips.

24. The method of claim 23, wherein the use information includes signal levels emitted by the mobile device across a radio frequency (RF) spectrum, and the method further comprises:
comparing the signal levels emitted by the mobile device to a baseline of RF emissions in locations the mobile device has traveled and/or during execution of application by the device, wherein the information indicating that patterns are detectable and/or one or more actionable recommendations for breaking or obfuscating the detectable patterns are output based on the signal levels emitted by the mobile device exceeding the baseline of RF emissions in the locations the mobile device has traveled and/or during execution of application by the device.

25. The method of claim 24, wherein the one or more actionable recommendations for obfuscating the detectable patterns include:
recommendation for modifying a time period when an application emitting signals in the RF spectrum is use or a region where the application is used;
recommendation for when and/or where to power down or not power down the mobile device;
recommendation for when and/or where a communication protocol emitting signals in the RF spectrum should or should not be used by the mobile device; and/or
recommendation for when, where and/or which wireless access point should or should not be used by the mobile device.

26. A non-transitory computer readable storage medium tangibly storing program instructions for prevention or obfuscation of patterns, the program instructions, when executed by a computing system including at least one processor, performing one or more of the functionalities comprising:
receiving, from one or more sources, use information related to use of a device;
identifying, based on the received use information, one or more detectable patterns; and
based on detecting that the one or more detectable patterns satisfy one or more conditions, outputting information indicating that patterns are detectable and/or one or more actionable recommendations for breaking or obfuscating the detectable patterns.

27. A method comprising:
receiving, from one or more sources, use information related to use of a device;
predicting, based on the received use information, detection of one or more patterns; and
based on predicting that the one or more patterns satisfy one or more conditions, generating use information related to the one or more sources for prevention or obfuscation detection of the one or more patterns.

28. The method of claim 27, wherein the device includes a mobile device, the one or more sources include one or more sensors included in the device, the detectable patterns include behavior patterns.

29. The method of claim 28, wherein the generated use information includes location information of the device and/or signal information for prevention or obfuscation detection of the one or more patterns.
